(19) United States
(12) Patent Application Publication
(10) Pub. No.: US 2010/0023783 A1
(43) Pub. Date: Jan. 28, 2010

(54) SYSTEM AND METHOD OF DECRYPTING ENCRYPTED CONTENT

(75) Inventor: Balagopalan Ambady, Broomfield, CO (US)

Correspondence Address: BROOKS KUSHMAN P.C., 1000 TOWN CENTER, TWENTY-SECOND FLOOR, SOUTHFIELD, MI, 48075, US

(73) Assignee: CABLE TELEVISION LABORATORIES, INC., Louisville, CO (US)

(21) Appl. No.: 11/965,542

(22) Filed: Dec. 27, 2007

(51) Int. Cl. G06F 21/24

(52) U.S. Cl. 713/193

(57) ABSTRACT

System and method of decrypting content. The content may be decrypted with decryption keys stored on a secured dongle. The dongle may be connect to a computer and used to decrypt the content for the computer, limiting the decryption-based processing demands on the computer. The computer may output the decrypted content to an output device for access by a user. The dongle may be single-use device pre-configured with a number of unchangeable keys and security measures.

### BACKGROUND OF THE INVENTION

1. Field of the Invention

The present invention relates to methods and systems of securing content, such as but not limited to securing content designated for playback from a computer or other processing entity having an ability to run debugger or rogue applications.

2. Background Art

A content provider or other entity having ownership rights in content may encrypt the content for subsequent playback, such as for storage and playback from a computer. The content may be encrypted such that one or more decryption keys may be required to decrypt the content. A DRM application operating on the computer may be configured to manage decryption keys stored on the computer so that the appropriate keys can be located and used to decrypt particular pieces of content. Limiting access to the keys is critical to preventing unauthorized access to the protected content. Some general purpose PC, however, lack sufficiently secured hardware locations for storing the keys. The DRM application, instead, may be forced to secure the keys by obfuscating their storage location on the PC with data hiding techniques or other security measures.

Even though various techniques may be employed to hide the keys, the storage of the keys on the computer can allow a debugger or other rouge application operating on the computer to locate and steal the keys. These types of applications can be used for monitoring source code, routines, messages, and other processes used by the DRM application to hide the keys. The program can then work back through the collected information to find the hiding (hard drive) locations of the keys. Storing the keys on the computer can be problematic since it is difficult to prevent applications from uncovering the keys, especially from applications that are running on the computer's operating system and relatively uninhibited in their ability to monitor the processes (DRM application) executing on the computer to hide the keys.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for protecting content in accordance with one non-limiting aspect of the present invention; and

FIG. 2 illustrates a start-up system for protecting content in accordance with one non-limiting aspect of the present invention.

### DETAILED DESCRIPTION OF THE PREFERRED EMBODIMENT(S)

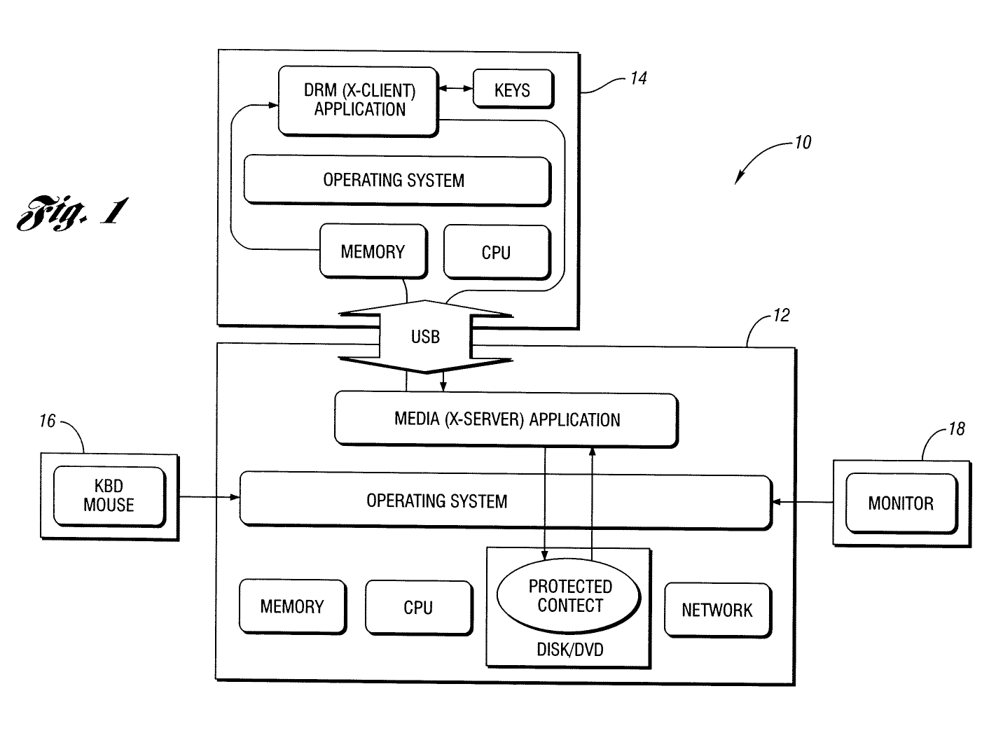

FIG. 1 illustrates a system 10 for protecting content in accordance with one non-limiting aspect of the present invention. The system 10 may include a computer 12, a digital rights management (DRM) dongle 14, a user controlled peripheral (keyboard/mouse) 16, and a monitor 18. The system 10 may be configured to facilitate decrypting encrypted content stored on or accessed through the computer 12 for display on the monitor 18. The computer 12 may be any type of computer, including one having a memory, central processing unit (CPU), hard/disc drive, network interface, and/or any number of other resources. The computer 12 may be loaded with an operating system to facilitate managing these and other computer resources.

The DRM dongle 14 may be a self-contained processing entity having a memory, CPU, and DRM application managed by its own operating system. The DRM dongle 14 may be removably connected to the computer 12 through a wireline (universal serial bus (USB)) or wireless communication medium. The DRM dongle 14 may be tamper resistant such that it self-destructs (i.e. zeros out all the bits) or otherwise locks itself from tampering if its physical structure is disrupted or if attempts are made to add applications or adjust its operating system without completing an authorization process. The operating system may be a small-footprint system limited to executing the operations specified by the present invention. Other operations and process, such as those required by debuggers and rouge applications, may be unsupportable by the operating system.

The present invention contemplates an arrangement where the DRM dongle 14 is connected to the computer 12 to decrypt encrypted content stored on the computer. For example, a content provider may allow encrypted content to be stored on the computer 12 for playback through a media player application. The content may be encrypted by the provider such that it can only be decrypted with one or more corresponding decryption keys. The DRM dongle 14 may include a number of these decryption keys or other features (certificates) that can be used by the DRM application to decrypt the encrypted content. The keys may be stored on the DRM dongle 14 instead of the computer in order to protect them from the above-described debugger and rogue applications. Because the DRM dongle 14 is tamper resistant, it may be very difficult for applications to locate the keys without causing the DRM dongle 14 to self-destruct or otherwise destroy the keys.

The keys may be provided to the DRM dongle 14 for storage in any suitable manner. One option may include the content provider pre-loading the DRM dongle 14 with a number of keys. This may be advantageous for use with customers that purchase a subscription to particular services or otherwise pre-purchased content for viewing. Another option may include transmitting the keys to the DRM dongle 14 by way of the network interface where the provider downloads in such a manner that the media application is forced to store keys on the DRM dongle 14. An identifier may be assigned to the DRM dongle 14 in order to limit/force transmission of the keys to a desired dongle. If an application other than that associated with the identified DRM dongle 14 attempts to intercepts the keys, the keys may self-destruct. The dongle 14 could be a one-time programmable device in that once it is pre-loaded with the keys and security measures contemplated by the present invention at the time of manufacturing and/or once the keys are initially loaded through the network connection or otherwise, no additional keys or re-programming can be subsequently performed on the dongle 14.

The media player application may operate in cooperation with the DRM dongle 14 to facilitate decrypting and displaying the content. The media player may provide a user interface that allows a user to select and control content for playback. If the user selects content requiring decryption with one or more of the keys included on the DRM dongle 14, the media player application may be configured to transfer the associated content to the DRM dongle 14 for decryption. The dongle 14 may decrypt the content and then transmit it back to the media player application for display on the monitor 18. The media player application may control playback of the content as if the content were decrypted on the computer 12. The DRM application may keep track of entitlements and other parameters to assess whether the user in entitled to access the desired content. If the subscription to the content has expired, the DRM application may provide an included portal or other user interface through which the user may re-purchase entitlements to the content, such as with communications carried out over the network interface.

The DRM application may be configured to encrypt the decrypted content prior to communicating it to the media player application. This may include the DRM application and the media player application establishing a secure communication medium using any number of encryption techniques. This additional encryption may be advantageous in preventing scraper applications or other rogue applications from capturing the decrypted content while it is being communicated to the computer. Rather than allowing playback of the protected content through a generic media player application included on the computer 12, the DRM dongle 14 may be configured to load the media player application on the computer 12 such that the secure communication medium may only be established with the DRM dongle 14 loaded media player application and the DRM application, and not a generic media player application previously included on the computer 12.

The DRM dongle 14 loaded media player application may be configured to supersede the operating system of the computer 12 or other user interfaces provided through the operating system so that the operating system is only allowed to process certain, authorized user inputs. The authorized user inputs may be previously authorized inputs associated with interacting with a user interface provided by the media player application, effectively rending any other inputs or attempted inputs as invalid. This may be helpful in preventing use of the peripheral devices 16 to instigate rogue applications since any user action or action not pre-authorized by the DRM dongle 14 loaded media player application will be invalid.

Optionally, the present invention contemplates the media player application overtaking any other user interfaces so that only the user interface of the media player application is shown. Attempts to engage other application windows and programs may be prohibited so that the user is unable to engage unauthorized operations that may be used to facilitate unauthorized access to the content. Access to the other computer resources may be restricted until the media player application is closed. The present invention contemplates prohibiting the operating system on the computer 12 from processing any inputs other than those available through the user interface provided by the DRM dongle 14.

The DRM dongle 14 may include its own clock (not shown). The clock may operate independently of a clock (not shown) included on the computer 12. The resistance of the DRM dongle 14 to tampering allows the dongle clock to be used as a secure clock for measuring entitlements and other time-based restrictions associated with accessing the protected content. Instead of issuing inquiries to the computer's clock when assessing entitlements, the DRM application may issue the inquiries to the more secure dongle clock. Applications operating on the computer 12 and the computer's operating system may be programmed or forced to issue inquires to the dongle clock instead of its own clock. This can be used to provide anti-rollback clock protections and guard against users extending their usage rights by resetting the computer's clock.

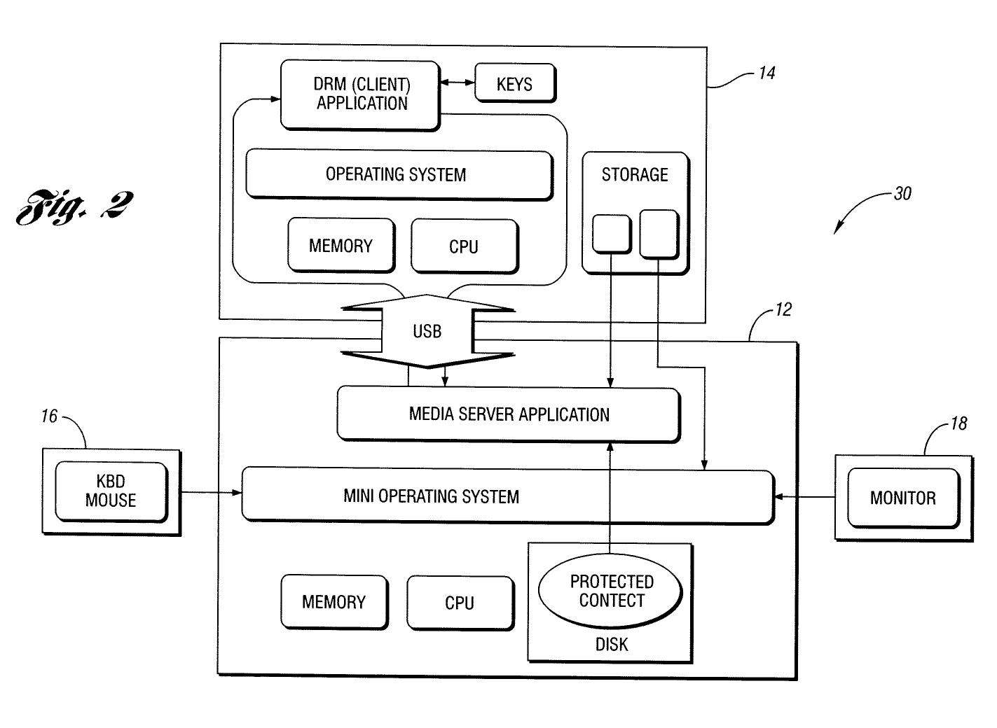

FIG. 2 illustrates a start-up system 30 for displaying protected content in accordance with one non-limiting aspect of the present invention. This system includes the DRM dongle 14 loading a mini (auxiliary) operating system on the computer 12 in place of the operating system shown in FIG. 1. This may require the DRM dongle 14 to be connected to the computer 12 when the computer is shut-off so that the auxiliary operating system is loaded in place of the computer's operating system during a subsequent boot-up sequence commonly employed to load computer operating systems. Because the auxiliary operating system loads in place of the computer's operating system, the computer's operating system may be unavailable until the DRM dongle 14 is disconnected and the computer is re-booted.

The DRM loaded auxiliary operating system may be a limited capability operating system programmed to execute a limited number of operations associated providing access to the content. Other inputs or unauthorized inputs may deemed invalid and the limited processing capabilities of the loaded operating system may prevent authorized applications stored on the computer 12 from executing, i.e., the computer stored applications may not even be initialized during boot-up since the computer's operating system is non-existent. The auxiliary operating system may be programmed with the DRM loaded media player application described above such that the DRM dongle 14 provides the operating system and media player application to the computer 12. The DRM application may be configured in the manner described above to secure communications with the computer 12, to limit authorized user inputs to those associated with interacting with the media player application interface, and/or to rely on the dongle clock to measure entitlements.

One non-limiting aspect of the present invention relates to providing a removable dongle that may be connected to a computer or other media playback device. The dongle may be configured to decrypt or descramble content stored or otherwise accessed through the computer, instead of relying on the computer to perform the decryption. The keys or other items required to decrypt the content may be securely stored on the dongle and limited to applications or processes executing on the dongle. The dongle may include self-destruct capabilities that allow the keys and/or other items on the dongle to be automatically destroyed if a user or application attempts to physically or logically access or facilitate access to the dongle in an unauthorized manner.

One non-limiting aspect of the present invention relates a DRM system (DRM) that may be installed on a USB Drive. Any keys and certificates needed to support the DRM may also installed on the USB drive. The DRM may include a web browser like interface and capabilities. The USB drive may include hardware encryption/decryption capabilities if its CPU is not powerful enough to do so in software. When a user plugs in the USB into a device, the device can install (any needed) drivers (on the PC) and commandeers the keyboard, video, mouse, and network. This is accomplished by the following steps: USB drive runs an X Windows Server program on the Host PC; USB drive runs a DRM application as a X Windows Client on the USB drive; secure connection is established between the X Server and Client using authentication technology typically used in X Window systems; the X Server on the PC now has access to the keyboard, mouse, and monitor (through the graphics system on PC)

Using the DRM, a user may be able to: browse already installed content (if any) on the PC for consumption and connect to an Operator's web site and purchase new content. When downloading new content, the DRM may be used to provide the necessary authentication credentials, and also a secure download path for the content. After the DRM is authenticated, and usage rights determined, the Operator's web site can encrypt the content using a new “content key”. Usage rights can be wrapped in to a “DRM license” where the new content key can be place. The license (including the content key) can be encrypted using the USB token's public key. Thereafter, the encrypted content cab be downloaded to the PC (for storage on the local drive), or directly on to the USB drive. The encrypted license can be downloaded directly in the USB drive's DRM. When the user is ready to consume content, the DRM can provide rights management, regardless of whether the content itself is stored on the USB drive itself (space permitting) or encrypted and stored on the local PC's hard-drive. The Licenses for the content (which includes the key and the usage rights associated with a particular content) can be stored on the USB drive (expired licenses maybe discarded to save space). The DRM on the USB can interpret the license and show the options to user. Depending on consumption, the DRM can update the license (say if the content allowed 3 “view” operations the DRM will decrement to 2 after user uses up one “view” operation).

The OS/DRM on the USB drive may be configured to be independent from the PC for memory/processing of protected content decryption so that there is less opportunity for the hacker to launch attacks. Since the USB may be tamper resistant, hackers cannot get at keys, or other secrets. Since the USB can control the video, the content (after decryption) can be sent directly to the video subsystem through the X Server on the PC. If needed, the DRM (through the X Server) can extend security by taking advantage of the PC Operating systems capabilities (like Vista PVP-OPM). The DRM may be responsible for enforcing usage rights. If needed, the DRM can report usage and other logs to the Operator's web site periodically. The Operator website can maintain a Revocation List of any revoked USBs. If user stores content on PC1, and now wants to consume content on a different device, all they may need to do is move the encrypted content (file) on to PC2, then move the USB token to the PC2—the USB-DRM can boot up and recognizes the content and uses the stored license to allow consumption.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for use in decrypting encrypted content, the system comprising:
a DRM dongle having an operating system, decryption application, and number of locally stored decryption keys, the operating system enabling the DRM application to decrypt the encrypted content with at least one of the stored keys; and
a computer having the encrypted content and a connection for removable connecting to the DRM dongle, the computer configured to relay the encrypted content to the DRM dongle for decryption, to receive the decrypted content from the DRM dongle, and to output the decrypted content to an output device.

2. The system of claim 1 wherein the computer includes a media player application for use in supporting selection and playback of the encrypted content, the media player application providing a user interface to facilitate receiving user inputs associated with supporting selection and playback of the encrypted content, wherein the DRM dongle instructions an operating system on the computer to ignore any inputs other than inputs pre-authorized for receipt through the user interface.

3. The system of claim 2 wherein the DRM dongle is configured to provide the media player application to the computer.

4. The system of claim 3 wherein the content is encrypted such that it can only be played back through the media player application provided to the computer from the DRM dongle.

5. The system of claim 2 wherein the DRM dongle only instructs to the media player application to ignore the inputs if the media player application is used to facilitate playback of encrypted content that must be decrypted with the DRM dongle.

6. The system of claim 1 wherein the computer is loaded with an auxiliary operating system provided by the DRM dongle, the auxiliary operating replacing an operating system on the computer and rendering any non-authorized operations on the computer as invalid.

7. The system of claim 1 wherein the computer and DRM dongle are configured to secure transmissions between the computer and DRM dongle with a public-private key security protocol.

8. The system of claim 6 wherein the decrypted content outputted to the output device is not secured with the public-private key security protocol.

9. The system of claim 1 wherein the computer stores other decryption keys besides the decryption keys stored on the dongle and is configured to use the other decryption keys to decrypt content suitable for decryption with the other decryption keys.

10. The system of claim 9 wherein the computer decrypts content with the other decryption keys without relaying the content to the DRM dongle for decryption.

11. The system of claim 1 wherein the DRM dongle includes a clock separate from a clock included on the computer and the content includes time-limited entitlement restrictions, wherein the media player application is required to verify validity of the time-limited entitlement restrictions with the clock on the DRM dongle and not the clock on the computer.

12. The system of claim 1 wherein the DRM dongle further includes a self-destruct setting that causes the DRM dongle to self-destruct if a user or application attempts to physically or logically access the DRM dongle in an unauthorized manner.

13. The system of claim 1 wherein the DRM dongle further includes a self-destruct setting that causes the DRM dongle to self-destruct if the locally stored decryption keys are removed or copied to the computer.

14. A method of decrypting encrypted content with a computer, the method comprising:
storing decryption keys on a DRM dongle configured to removably connect to the computer, the keys being configured to facilitate decrypting the encrypted content;
receiving the encrypted content with the DRM dongle through communications carried out over the removable connection to the computer;
decrypting the encrypted content with an application included on the DRM dongle and according to the decryption keys stored on the DRM dongle; and
outputting the decrypted content to the computer through communications carried out over the removable connection.

15. The method of claim 14 further comprising the DRM dongle providing instructions to the computer for instructing an operating system on the computer to invalid non-authorized user inputs.

16. The method of claim 14 further comprising initiating a self-destruct of the DRM dongle if a user or application attempts to physically or logically access the DRM dongle in an unauthorized manner.

17. The method of claim 14 further comprising outputting an auxiliary operating system to the computer for replacing an operating system of the computer and preventing the DRM dongle from decrypting the encrypted content unless the auxiliary operating system has replaced the operating system of the computer.

18. The method of claim 14 further comprising securing communications between the DRM dongle and computer with a private-public key protocol.

19. A DRM dongle comprising:
an interface for removable connecting to a computer, the interface sufficient to permit electronic communications between the DRM dongle and the computer;
a number of decryption keys stored according to a self-destruct protocol that zeros-out the decryption keys upon determining an attempt to access the keys in an unauthorized manner; and
an application and processor arrangement having capabilities sufficient to decrypt content received through the interface with one or more of the encryption keys and to facilitate outputting the decrypted content from the interface.

20. The DRM dongle of claim 19 further comprising a non-programmable memory and operating system wherein the keys are stored in the memory at the time of manufacturing and the operating system is unable to allow additional keys to be stored on the memory after the keys are initially stored at the time of manufacturing.
